(19) United States
(12) Patent Application Publication
(10) Pub. No.: US 2016/0279646 A1
(43) Pub. Date: Sep. 29, 2016

(54) FILTERING OF AN EXHAUST GAS OF A METALLURGICAL PLANT, WHICH EXHAUST GAS COMPRISES SOLID PARTICLES

(71) Applicant: PRIMETALS TECHNOLOGIES AUSTRIA GMBH, Linz (AT)

(72) Inventors: Philipp AUFREITER, Linz (AT); Johann FLEISCHANDERL, St. Oswald b. Fr. (AT); Franz HARTL, Linz (AT); Thomas KEUSCH, Linz (AT); Martin LEHOFER, Plainsboro, NJ (US); Andreas ROHRHOFER, Linz (AT); Florian WACKERLE, Wien (AT); Michael WEINZINGER, Neuhofen a. d. Krems (AT)

(21) Appl. No.: 15/036,003

(22) PCT Filed: Nov. 6, 2014
(86) PCT No.: PCT/EP2014/073861

§ 371 Date: May 11, 2016

(30) Foreign Application Priority Data
Nov. 13, 2013 (EP) 13192681.8

(51) Int. Cl. B03C 3/68; G05B 13/02

(52) U.S. Cl. CPC B03C 3/68; G05B 13/021; B03C 2201/24

(57) ABSTRACT

A method for operating a filter system (1) for filtering an exhaust gas (11) of a metallurgical plant (12), which exhaust gas (11) comprises solid particles (10), wherein the filter system (1) has at least one electrode pair (2), to each of which an electrical power and/or an electrical voltage and/or an electrical current can be applied. A system for operating such a filter system includes (1) a plant for filtering an exhaust gas (11) of a metallurgical plant (12). The exhaust gas (11) includes solid particles (10). The metallurgical plant (12) includes such a filter system (1). In order to filter an exhaust gas (11) of a metallurgical plant (12), which exhaust gas (11) comprises solid particles (10), in a resource-saving manner, method steps include: identifying a process phase (7) of the metallurgical plant (12), identifying a feed-forward (8) of the respective electrode pair (2) dependent on the identified process phase (7), wherein the identified feed-forward (8) includes an electrical power and/or an electrical voltage and/or an electrical current to be applied, applying to the respective electrode pair (2) according to the identified feed-forward (8).

### CROSS-REFERENCE TO RELATED APPLICATIONS

The present application is a 35 U.S.C. §§371 national phase conversion of PCT/EP2014/073861, filed Nov. 6, 2014, which claims priority of European Patent Application No. EP 13192681.8, filed Nov. 13, 2013, the contents of which are incorporated by reference herein. The PCT International Application was published in the German language.

### TECHNICAL BACKGROUND

The invention relates to a method for operating a filter system for filtering an exhaust gas of a metallurgical plant, wherein the exhaust gas contains solid particles, and wherein the filter system has at least one electrode pair, and to each electrode an electrical power and/or an electrical voltage and/or an electrical current can be applied.

the method steps comprise:
identifying a process phase of the metallurgical plant,
determining a respective feedforward of the respective electrode pair, which feedforward is dependent on the identified process phase, wherein the respective determined feedforward comprises a respective electrical power and/or electrical voltage and/or electrical current to be applied,
applying the electrical power and/or voltage and/or current to the respective electrode pair in accordance with the respective determined feedforward.

The invention further relates to a system for operating such a filter system and to a plant for filtering an exhaust gas of a metallurgical plant, wherein the exhaust gas contains solid particles, and wherein the metallurgical plant comprises such a filter system.

In metallurgical industrial plants, electrical filters, also known as electrostatic precipitators, are employed for cleaning exhaust gases. These filters operate according to the principle that by ionization of the dust particles in the exhaust gas by means of two plates, which are referred to as the discharge electrode and the collecting electrode, the dust particles are drawn to one plate. The dust particles are dislodged from the plates by a mechanical apparatus, e.g. by shocks applied to the plates. The dust particles drop from the plates and are transported to a dust container, where they are collected. An electrostatic precipitator can comprise approx. 30 plate pairs, for example.

The contamination of the exhaust gas with dust is dependent on the process state of the metallurgical plant that supplies the filter. In the case of a converter, the greatest dust concentration occurs e.g. during the refining process, in contrast to scrap charging, in which the dust concentration is low.

Electrostatic precipitators are often operated in metallurgical industrial plants in an unregulated manner, irrespective of the process state and the dust concentration that is consequently to be expected in the exhaust gas. This means that the strength of the electrical field between the plates remains constant during the entire production process. A shutdown in the event of production downtimes is in this case performed manually by the operating personnel.

An electrostatic precipitator of the aforesaid type and a method for its operation is known from DE 632 608 C, for example.

A method of the type cited in the introduction and the associated system are known from EP 0 039 617 A1, for example.

A multi-stage control structure which is used within the context of the control of electrostatic precipitators is known from DE 102 14 185 A1, wherein the different units of the control structure exchange data with one another in a cyclic and event-driven manner.

A method for operating an electrostatic precipitator is known from DE 30 48 979 A1. The current dust content of the clean gas is measured continuously. In the event of a deviation from the selected setpoint value, the measured value controls the high voltage in such a way that a substantially constant dust content is maintained in the clean gas.

A method for operating an electrostatic precipitator is known from EP 0 210 675 A1, wherein the electrostatic precipitator has at least one electrode pair to which an electrical power, an electrical voltage and/or an electrical current are/is applied.

A method for operating an electrostatic precipitator is known from DE 100 23 821 A1, wherein the specified setpoint values for the actuating variable are adaptively adjusted to fit actual or changed operating conditions in accordance with predefined learning strategies. The adjustment is effected by means of a cyclically operating device for specifying a setpoint value for the actuating variable on the basis of two measured values obtained independently of one another.

### SUMMARY OF THE INVENTION

The object underlying the invention is to provide a method and a device by means of which an exhaust gas which contains solid particles that is produced by a metallurgical plant can be filtered in a manner that is more economical in the use of resources, wherein effective filtering of the generated exhaust gas is reliably ensured nonetheless.

This object is achieved by means of a method of the type cited in the introduction wherein the method comprises the following method steps:
attempting to identify a process phase of the metallurgical plant,
if the process phase can be identified, determining a respective feedforward of the respective electrode pair, which feedforward is dependent on the identified process phase, wherein the respective determined feedforward comprises a respective electrical power and/or a respective electrical voltage and/or a respective electrical current to be applied, and
applying the respective electrical power and/or electrical voltage and/or electrical current to the respective electrode pair in accordance with the respective determined feedforward, and
if the process phase cannot be identified, applying a respective emergency electrical power and/or a respective emergency electrical voltage and/or a respective emergency electrical current to the respective electrode pair in accordance with a respective emergency feedforward.

This object is furthermore achieved in a system of the type cited in the introduction wherein the system has a computing unit configured for identifying a process phase of the metallurgical plant and a respective feedforward of the respective electrode pair, which feedforward is dependent on the identified process phase, can be determined, wherein the respective determined feedforward comprises a respective electrical power and/or a respective electrical voltage and/or a respective electrical current to be applied, and wherein the computing unit is embodied apply a respective emergency electrical power and/or a respective emergency electrical voltage and/or a respective emergency electrical current to the respective electrode pair in accordance with a respective emergency feedforward if the process phase cannot be identified.

Finally, this object is achieved by a plant of the type cited in the introduction wherein the plant has a system of that type.

The filter system has at least one electrode pair, each pair of which is embodied as a pair of plates, for example. Preferably, the filter system is subdivided into two or more fields or regions which are arranged for example one behind the other in the flow direction of the exhaust gas, wherein at least one electrode pair is provided in each of the fields.

In particular, the respective feedforward of the respective electrode pair, which feedforward is dependent on the identified process phase, is specified in advance. The respective feedforward in particular provides separate parameters for a plurality of electrode pairs in different fields. The separate parameters in this case relate to the respective electrical power and/or to the respective electrical voltage and/or to the respective electrical current to be applied. Where necessary, the feedforward may also include a rotational speed of a ventilator or exhaust fan which is part of the filter system and which draws the exhaust gas through the electrostatic precipitator or the at least one electrode pair. If the feedforward includes a rotational speed of that type, the corresponding ventilator or exhaust fan is operated at a rotational speed in accordance with the feedforward. Generally, the respective feedforward can be understood as an actuating variable or as a setpoint variable for the respective quantity.

A high-voltage energy supply is preferably used to provide the at least one electrode pair with the respective electrical power and/or the respective electrical voltage and/or the respective electrical current to be applied. If an electrical power is specified as an actuating variable by the respective feedforward, then for example the respective voltage and/or the respective current to be applied are/is chosen or regulated in such a way that the desired power is delivered to the respective electrode pair. In an analogous procedure, the respective electrical current to be applied can be chosen or regulated in such a way that a suitably selected electrical voltage is applied to the respective electrode pair. In the event that the filter system has a plurality of electrode pairs in different fields it is advantageously provided that electrical power and/or voltage and/or current can be applied separately to the electrode pairs of different fields.

The application of power and/or voltage and/or current to the respective electrode pair is initiated by the computing unit, which is preferably connected to the respective high-voltage electrode pair is supplied in accordance with the respective determined feedforward, which is in each case dependent on the identified process phase of the metallurgical plant. In the example of a converter as the metallurgical plant, the following process phases, among others, are conceivable, for which the technical terms often used are: charging or scrap charging, ignition, blowing, tapping, slag splashing. Since different exhaust gas volume flows or different exhaust gas concentrations are to be expected for the different process phases, electrical power and/or voltage and/or current can consequently be applied to the respective electrode pair in accordance with a respective adjusted feedforward.

For example, a particularly powerful feedforward of the respective electrode pair is required for the process phase “blowing”, i.e. the injection of oxygen, since particularly large volumes of exhaust gas containing in particular a comparatively large number of solid particles are generated during this phase. Accordingly, a comparatively high electrical power and/or voltage and/or a comparatively high electrical current are/is applied to the respective electrode pair in order to filter out the greatest possible number of solid particles from the exhaust gas.

On the other hand, a comparatively weak feedforward of the respective electrode pair is sufficient for the process phase “scrap charging”, i.e. the loading of the material that is to be processed in the converter, since comparatively small exhaust gas volumes and comparatively small volumes of solid particles are to be expected during this phase. A comparatively large power saving can therefore be realized during the filtering of the exhaust gas, since the principle of operation of an electrostatic precipitator presupposes that in the case of a low dust loading, the voltage can increase without flashover up to the maximum and that this results in a correspondingly high current. Thus, the highest power consumption is present at the lowest dust concentration, such that the power draw of the filter system is at a maximum in the case of low levels of contamination of an exhaust gas and when the filter system is driven or operated in a constant manner.

In particular, when the filter system has a plurality of fields, each having at least one electrode pair, the level of power and/or voltage and/or current to be applied to the respective electrode pair or electrode pairs of the respective region of the filter system can be specified for each individual one of the process phases.

The method according to the invention enables the filtering capacity of the filter system to be adjusted by allowing separate actuation of the respective electrode pair, the adjustment being based on the different process phases of the upstream metallurgical plant and in particular on likely exhaust gas volumes resulting therefrom. This enables the power consumption of electrical exhaust gas filters in metallurgical industrial plants to be minimized as a function of the process phases, in particular while complying with emission limits. As a result, the method according to the invention permits a more resource-friendly filtering of the solid particles from the exhaust gas of the metallurgical plant.

Savings in power consumption of up to 60% were successfully achieved for the filter system of a converter in pilot trials. This may be equivalent to a saving of approx. ε100,000 per annum in electricity costs when typical electricity tariffs in the industry are applied.

In an advantageous embodiment of the invention, the metallurgical plant has an automation system, wherein the automation system provides the process phase of the metallurgical plant.

In particular, the automation system of the metallurgical plant is linked to the computing unit. As a result, identifying the process phase can be realized reliably and with comparatively little technical overhead. In this case, the automation system can be assigned to Level 1 or Level 2 of the automation pyramid. In particular, the automation system controls or regulates the processing processes of the metallurgical plant, which are directly linked to the process phases that are to be identified. The respective process phase of the metallurgical plant can therefore be identified for example based on the automation system communicating the current process phase of the metallurgical plant to the computing unit. To that end, the computing unit can for example send a query in respect of the process phase to the automation system or a cyclical transmission of the current process phase can be provided.

In a further advantageous embodiment of the invention, the process phase is provided each time there is a change in the process phase of the metallurgical plant.

A particularly efficient and yet very reliable communication is achieved by the current process phase being provided only when there is a change in the process phase.

In a further advantageous embodiment of the invention, the metallurgical plant has a converter, wherein a position and/or a rotation angle of the converter being provided for the purpose of identifying the process phase of the metallurgical plant.

In this case, the position and/or the rotation angle of the converter correlate/correlates with the current process phase of the metallurgical plant. By providing one of the variables or from both variables, it is therefore possible to identify the current process phase. As a result, the respective feedforward of the respective electrode pair is in turn determined.

In a further advantageous embodiment of the invention, the filter system has an input dust sensor which is arranged fluidically upstream of the at least one electrode pair and which measures an input concentration of the solid particles in the exhaust gas flowing into the filter system. The process phase of the metallurgical plant is identified on the basis of the measured input concentration.

As explained in the foregoing, the different process phases of the metallurgical plant account for different exhaust gas volumes and in particular different concentrations of the solid particles in the exhaust gas. The input dust sensor measures the input concentration of the solid particles in the exhaust gas flowing into the filter system. The measured quantity is used to identify the current process phase of the metallurgical plant.

This permits the process phase to be identified independently of the metallurgical plant and particularly independent of its automation system. For example, the unexpected or unwanted presence of a particular process phase can also be identified in this way.

In the event that the identification of the process phase is based in addition on a connection to the automation system of the metallurgical plant, it is possible to perform an independent check of the automation system or of the metallurgical plant. This can be used for example for providing feedback to the automation system or the metallurgical plant, if discrepancies occur between the process phase indicated by the automation system and the process phase identified by means of the input dust sensor.

In an alternative advantageous embodiment of the invention, the filter system has an input dust sensor which is arranged fluidically upstream of the at least one electrode pair and the sensor measures an input concentration of the solid particles in the exhaust gas flowing into the filter system. The respective feedforward of the respective electrode pair is calculated from the measured input concentration by a mathematical formula.

In particular, the mathematical formula establishes a relationship between the measured input concentration and the respective requisite feedforward. Accordingly, the respective feedforward of the respective electrode pair is calculated directly from the measured input concentration with the aid of the mathematical formula, without the intermediate step of identifying the respective process phase being necessary for that purpose.

It is, however, also conceivable for the mathematical formula to be used initially for identifying the respective process phase of the metallurgical plant, and the respective feedforward being determined from the respective identified process phase.

In a further advantageous embodiment of the invention, the respective feedforward of the respective electrode pair is determined by means of a predefinable table in which there is a link stored between the identified process phase and the respective electrical power and/or electrical voltage and/or electrical current that is to be applied.

In particular, the predefinable table contains the respective feedforward for each of the possible process phases, for example in the form of parameters relating to each of the electrode pairs or each of the above-explained fields of the filter system. Thus, for each process phase, the respective electrical power and/or the respective electrical voltage and/or the respective electrical current to be applied are/is actually stored in the predefinable table. In this case, the respective feedforward or the previously cited physical variables can be determined in advance, for example by conducting corresponding trials.

The predefinable table with the links stored therein enables a comparatively simple operating method for the filter system. In particular, if the process phase is identified with the aid of the automation system of the metallurgical plant, the respective feedforward can thus be determined without great effort. To that end, for example, the computing unit reads out the entries in the predefinable table that are associated with a specific process phase and initiates a corresponding application of electrical power and/or voltage and/or current to the respective electrode pair in accordance with the determined feedforward. Preferably, the predefinable table is in this case stored in a memory unit associated with the computing unit or connected to the computing unit.

In an example of a metallurgical plant in the form of a converter, the following exemplary feedforward may be stored in the predefinable table:

| Identified | Setpoint | Setpoint | | Setpoint |
|---|---|---|---|---|
| process | value | value | | value |
| phase | Field 1 | Field 2 | . . . | Field n |
| Scrap | 10% | 10% | . . . | . . . |
| charging | | | | |
| Ignition | 70% | 30% | . . . | . . . |
| Blowing | 100% | 100% | . . . | . . . |
| Tapping | 50% | 40% | . . . | . . . |
| Slag | 70% | 30% | . . . | . . . |
| splashing | | | | |
| . . . | . . . | . . . | . . . | . . . |
| Hot standby | 10% | 0% | 0% | 0% |
| Emergency | 100% | 100% | . . . | . . . |
| operation | | | | |

In a further advantageous embodiment of the invention, the filter system has an output dust sensor which is arranged fluidically downstream of the at least one electrode pair and which measures an output concentration of the solid particles in the exhaust gas flowing out of the filter system, the respective feedforward of the respective electrode pair is varied as a function of the measured output concentration.

The dust intensity in the output airflow of the filter system is measured or monitored, in particular continuously, by the output dust sensor. In this case, the output dust sensor can be used for performing a corrective adjustment or a fine adjustment of the respective feedforward. This can be of advantage for example if the filter system filters more thoroughly or less thoroughly than initially assumed and as a consequence, fewer or more solid particles are present in the exhaust gas when the latter exits the filter system.

In a further advantageous embodiment of the invention, the varied feedforward is in this case stored in the predefinable table.

Storing the varied feedforward in the predefinable table enables a type of closed-loop control, since a feedback is taken into account for determining the feedforward. The feedback is realized by adjustment of the feedforward for the respective process phase on the basis of the data of the output dust sensor, such that for example a lower voltage is provided for a respective electrode pair than was originally stored for said process phase in the table. The adjusted feedforward is finally stored in the table, as a result of which older entries for the respective process phase are overwritten.

In a further advantageous embodiment of the invention, the respective feedforward of the respective electrode pair is in this case varied in such a way that a predefinable upper output concentration is not exceeded.

Statutory limit values which must be complied with during the filtering of the exhaust gas of the metallurgical plant can be stored as the predefinable upper output concentration, for example. The adjustment of the respective feedforward is preferably performed for all possible process phases such that an an overall operation of the filter system can be ensured which results in exhaust gas emissions within the bounds of the statutory limit values.

In a further advantageous embodiment of the invention, the respective feedforward of the respective electrode pair is in this case varied in such a way that a predefinable lower output concentration is not undershot.

Values which are comparatively low and vary for example in the range of only 20% of the statutory limit values can be stored as the predefinable lower output concentration. Adjusting the respective feedforward makes sense in particular when the output concentration measured by the output dust sensor turns out to be very low and in particular lower than previously expected. For this eventuality the respective feedforward can be varied in such a way that the emission of exhaust gas from the filter system is increased somewhat. As a result, considerable energy savings, and consequently also cost savings, can be realized in some cases. It makes sense to increase the emission of exhaust gas in this case in such a way that statutory limit values are complied with.

In a further advantageous embodiment of the invention, measured values of an input dust sensor, which is arranged fluidically upstream of the at least one electrode pair and by means of which an input concentration of the solid particles in the exhaust gas flowing into the filter system is measured, and/or of an output dust sensor which is arranged fluidically downstream of the at least one electrode pair and by means of which an output concentration of the solid particles in the exhaust gas flowing out of the filter system is measured, are evaluated within the scope of the attempt to identify the process phase, wherein the process phase is rated as not identifiable if the input dust sensor and/or the output dust sensor deliver/delivers unreliable measured values.

The respective emergency feedforward can be utilized if problems occur, in order to ensure adequate filtering of the exhaust gas and therefore compliance with statutory limit values even in such situations. The respective emergency feedforward is chosen, for example, such that the respective electrode pair is operated during the process phase during which the exhaust gas contains a maximum of solid particles and it is necessary to achieve the greatest filtering effect. The emergency voltage is in this case also referred to as the minimum value of the discharge limit.

A trouble state of said type is present when the process phase of the metallurgical plant is not available or is unknown. This can be the case, for example, when the metallurgical plant possesses an automation system which fails or malfunctions. Alternatively or in addition, such a trouble state is present when the filter system has an input dust sensor and/or an output dust sensor, where one of the sensors or both of the sensors delivers or deliver unreliable measured values. Accordingly, ranges which are considered reliable or unreliable are specified in advance for the respective measured values.

In a further advantageous embodiment of the invention, a respective standby electrical power and/or a respective standby electrical voltage and/or a respective standby electrical current is applied to the respective electrode pair in accordance with a respective standby feedforward if the metallurgical plant is operated in a standby state for longer than a predefinable period of time.

The standby state is present in particular in the form of a production downtime of the metallurgical plant. It is conceivable that a melt which is temporarily not processed further is contained in a converter of the metallurgical plant. In this case, the metallurgical plant continues to emit a comparatively low volume of exhaust gas containing comparatively few solid particles. Accordingly, the respective electrode pair can be operated in a comparatively energy-saving mode of operation while complying with statutory limit values.

### BRIEF DESCRIPTION OF THE DRAWINGS

The invention is described and explained in more detail below with reference to the exemplary embodiments depicted in the figures, in which:

FIG. 1 shows a first exemplary embodiment of the plant according to the invention,

FIG. 2 shows a second exemplary embodiment of the plant according to the invention,

FIG. 3 shows an exemplary temporal relationship between a respective feedforward and process phases of a converter, and

FIG. 4 shows an exemplary schematic of an operating concept of a further exemplary embodiment of the plant according to the invention.

### DESCRIPTION OF EMBODIMENTS

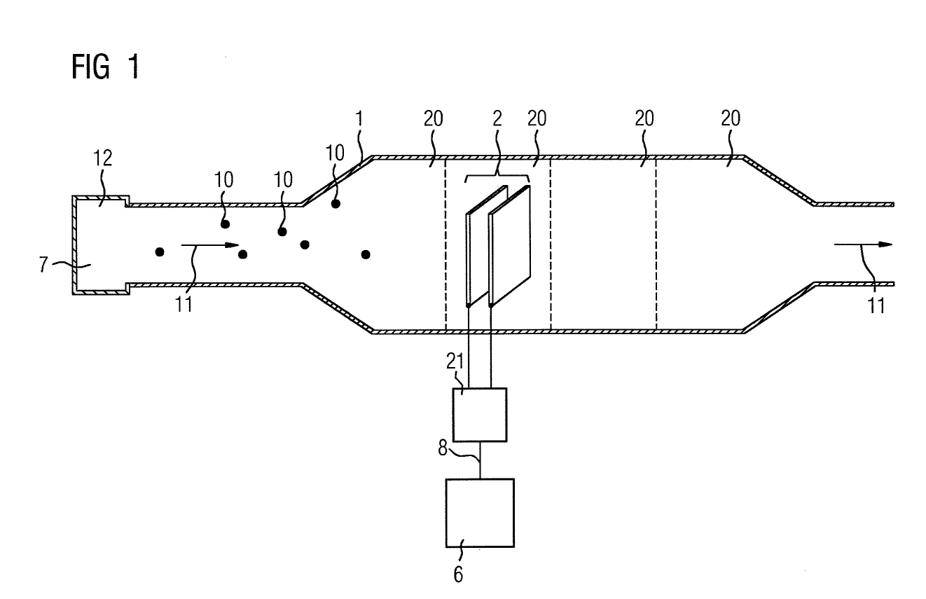

FIG. 1 shows a first exemplary embodiment of the plant according to the invention. The plant possesses a filter system 1 for filtering an exhaust gas 11 containing solid particles 10 which is fed to the plant by a metallurgical plant 12. The filtering is performed with the aid of an electrode pair 2 to which an electrical power can be applied and wherein the filtering is implemented for example as a pair of plates. Within the scope of the first exemplary embodiment, the filter system 1 is furthermore subdivided into four sequential fields 20 in the flow direction.

An electrical power is applied to the electrode pair 2 in accordance with a feedforward 8. The feedforward 8 is determined by a computing unit 6 as a function of a process phase 7 of the metallurgical plant 12. The computing unit 6 transmits the determined feedforward 8 to a connected high-voltage energy supply 21, which finally supplies the electrode pair 2 with the electrical power that is to be applied.

Alternatively or in addition, the feedforward 8 can be embodied such that an electrical voltage and/or an electrical current are/is applied to the electrode pair 2.

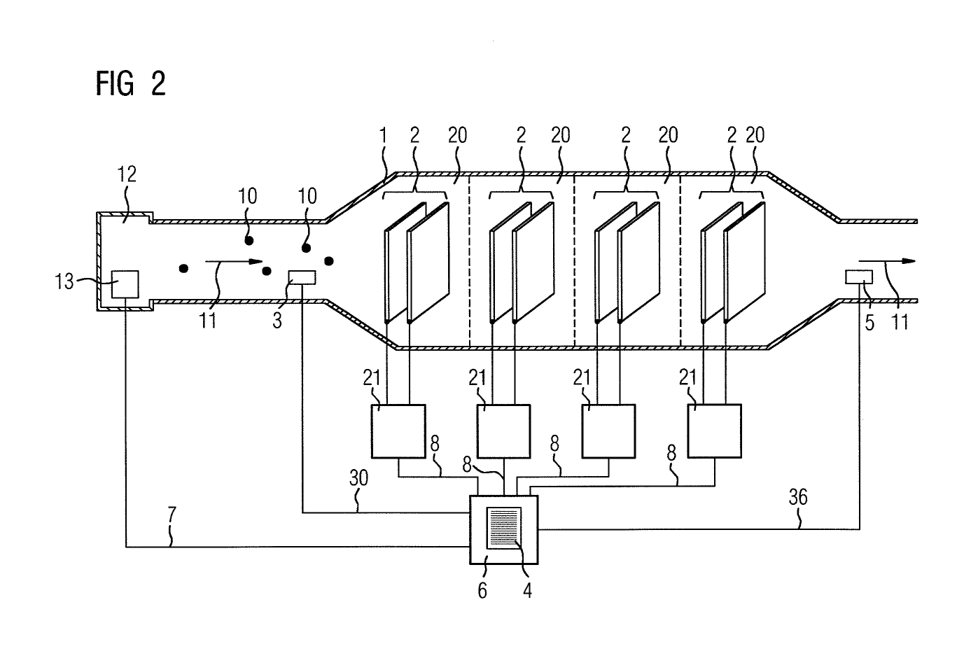

FIG. 2 shows a second exemplary embodiment of the plant according to the invention. In this case the same reference numerals as in FIG. 1 designate like objects.

The filter system 1 has four electrode pairs 2, each of which is accommodated in a separate field 20 of the filter system 1 and each of which may be supplied by a separate high-voltage energy supply 21. Also provided are an input dust sensor 3 and an output dust sensor 5, which are arranged fluidically upstream and downstream, respectively, of the electrode pairs 2 which measure an input concentration 30 and an output concentration 36, respectively, of the solid particles 10 in the exhaust gas 11 in each case.

The computing unit 6 is connected to the input dust sensor 3 and to the output dust sensor 5 such that the respective concentrations of the solid particles 10 at the sensor can be communicated to the computing unit 6. In addition, the computing unit 6 is connected to an automation system 13 of the metallurgical plant 12 such that the respective process phase 7 of the metallurgical plant 12 is accessible to the computing unit 6.

Starting from the process phase 7 which the computing unit 6 receives for example directly from the automation system 13 or identifies on the basis of the transmitted input concentration 30, the computing unit 6 determines the respective feedforward 8 for the respective electrode pair 2. For this purpose the computing unit 6 refers to a predefinable table 4 in which a link between the identified process phase 7 and the respective feedforward 8 is stored, in particular the respective electrical power and/or the respective electrical voltage and/or the respective electrical current to be applied.

In this case the respective feedforward 8 of the respective electrode pair 2 can be calculated from the measured input concentration 30 in particular by means of a mathematical formula.

In addition or alternatively, the respective feedforward 8 of the respective electrode pair 2 may be varied as a function of the measured output concentration 36, wherein the varied feedforward 8 can be stored in the predefinable table 4.

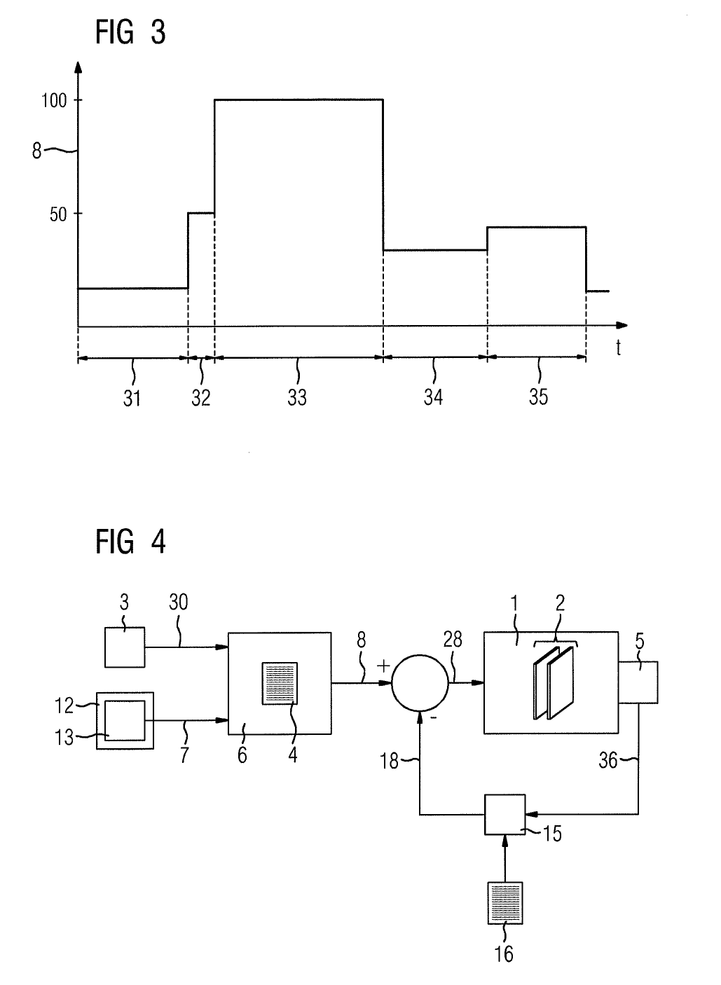

FIG. 3 shows an exemplary temporal relationship between a feedforward 8 and process phases 7 of a converter. In this case the time is plotted on the x-axis and the feedforward 8, in the form of an electrical power that is to be applied, is plotted on the y-axis. The electrical power is to be applied to a respective electrode pair 2 in order to achieve a satisfactory filtering of an exhaust gas 11 of the converter. A different magnitude of electrical power is required in order to ensure a satisfactory filtering of the exhaust gas 11 as a function of the process phases 7 “scrap charging”, which takes place during the time interval 31, “ignition” 32, “blowing” 33, “tapping” 34 and “slag splashing” 35. For example, the greatest concentration or volume of exhaust gas 11 is to be observed during the oxygen injection phase (“blowing” 33), which means that the greatest amount of electrical power must also be made available to the respective electrode pair 2 at that time.

FIG. 4 shows an exemplary schematic of an operating concept of a further exemplary embodiment of the plant according to the invention. The plant possesses a filter system 1 having an electrode pair 2 and an input dust sensor 3 and an output dust sensor 5, each of which is arranged in the filter system 1. Also provided is an automation system 13 of a metallurgical plant 12, and the automation system 13 and the input dust sensor 3 are connected to a computing unit 6. In this case, the input dust sensor 3 transmits an input concentration 30 and the automation system 13 communicates a process phase 7 of the metallurgical plant 12 to the computing unit 6. The computing unit 6 identifies the process phase 7 from the input concentration 30 or uses the process phase 7 received from the automation system 13 in order to determine the feedforward 8 with reference to a predefinable table 4.

The determined feedforward 8 can be used directly for applying electrical power and/or voltage and/or current to the electrode pair 2 or varied via a control loop into a type of controlled feedforward 28 which is applied to the electrode pair 2. The controlled feedforward 28 can therefore be understood as the above-explained varied feedforward which can be stored in particular in the predefinable table 4.

In this case the control loop provides that an output concentration 36 determined by the output dust sensor 5 is transmitted to a control unit 15 which performs a comparison with predefinable limit values 16 and derives control parameters 18 therefrom which are processed together with the feedforward 8 to produce the controlled feedforward 28. The predefinable limit values 16 can be in particular an above-explained predefinable upper output concentration or a predefinable lower output concentration, wherein the control unit 15 can also be integrated in the computing unit 6. The control parameters 18 are used in particular for varying the feedforward 8 determined by the computing unit 6 and consequently for applying electrical power and/or voltage and/or current to the electrode pair 2 in accordance with the controlled feedforward 28.

Alternatively or in addition, the predefinable table 4 of the computing unit 6 is varied or adapted as a function of the control parameters 18, with the result that entries in the predefinable table 4 are overwritten.

To sum up, the invention relates to a method for operating a filter system for filtering an exhaust gas of a metallurgical plant, which exhaust gas contains solid particles, wherein the filter system has at least one electrode pair, to each of which an electrical power and/or an electrical voltage and/or an electrical current can be applied. The invention further relates to a system for operating a filter system of said type and to a plant for filtering an exhaust gas of a metallurgical plant, which exhaust gas contains solid particles, and which metallurgical plant comprises a filter system of said type. In order to provide a method or a device by means of which an exhaust gas containing solid particles that is produced by a metallurgical plant can be filtered in a more resource-friendly manner, the following method steps are proposed:
attempting to identify a process phase of the metallurgical plant,
if the process phase can be identified, determining a respective feedforward of the respective electrode pair, which feedforward is dependent on the identified process phase, wherein the respective determined feedforward comprises a respective electrical power and/or a respective electrical voltage and/or a respective electrical current to be applied, and
applying the electrical power and/or voltage and/or current to the respective electrode pair in accordance with the respective determined feedforward, and
if the process phase cannot be identified, applying a respective emergency electrical power and/or a respective emergency electrical voltage and/or a respective emergency electrical current to the respective electrode pair in accordance with a respective emergency feedforward.

This object is further achieved by means of a system of the type cited in the introduction wherein the system has a computing unit configured for implementing these method steps. Finally, this object is achieved by a plant of the type cited in the introduction which has a system of said type.

1. A method for operating a filter system for filtering an exhaust gas of a metallurgical plant;
wherein the exhaust gas contains solid particles;
wherein the filter system includes at least one electrode pair and an electrical power and/or an electrical voltage and/or an electrical current may be applied to each of the electrodes;
method comprising steps of:
attempting to identify a process phase of the metallurgical plant;
if the process phase is identified, determining a respective feedforward of the respective electrode pair, wherein the determined feedforward is dependent on the identified process phase, the respective determined feedforward comprises a respective electrical power and/or a respective electrical voltage and/or a respective electrical current to be applied; and
applying the respective electrical power and/or electrical voltage and/or electrical current to the respective electrode pair in accordance with the respective determined feedforward; and
if the process phase cannot be identified, applying a respective emergency electrical power and/or a respective emergency electrical voltage and/or a respective emergency electrical current to the respective electrode pair in accordance with a respective emergency feedforward.

2. The method as claimed in claim 1, wherein the metallurgical plant has an automation system, configured to provide the process phase of the metallurgical plant.

3. The method as claimed in claim 2, further comprising providing the process phase when there is a change in the process phase of the metallurgical plant.

4. The method as claimed in claim 1, wherein the metallurgical plant includes a converter, wherein a position and/or a rotation angle of the converter are/is provided for identifying the process phase of the metallurgical plant.

5. The method as claimed in claim 1, wherein the filter system includes an input dust sensor arranged fluidically upstream of the at least one electrode pair;
the method further comprising:
measuring an input concentration of the solid particles in the exhaust gas flowing into the filter system by operating the input dust sensor; and
identifying the process phase of the metallurgical plant on the basis of the measured input concentration.

6. The method as claimed in claim 1, wherein the filter system includes an input dust sensor arranged fluidically upstream of the at least one electrode pair;
the method further comprising:
measuring an input concentration of the solid particles in the exhaust gas flowing into the filter system by operating the input dust sensor; and
calculating the respective feedforward of the respective electrode pair based on measured input concentration by means of a mathematical formula.

7. The method as claimed in claim 1, further comprising:
determining the respective feedforward of the respective electrode pair by a predefinable table in which a link between the identified process phase and the respective electrical power and/or electrical voltage and/or electrical current to be applied is stored.

8. The method as claimed in claim 1, wherein the filter system includes an output dust sensor arranged fluidically downstream of the at least one electrode pair;
measuring an output concentration of the solid particles in the exhaust gas flowing out of the filter system with the output dust sensor; and
varying the respective feedforward of the respective electrode pair as a function of the measured output concentration.

9. The method as claimed in claim 7, further comprising storing the varied feedforward is stored in the predefinable table.

10. The method as claimed in claim 8, further comprising varying the respective feedforward of the respective electrode pair such
that a predefinable upper output concentration is not exceeded.

11. The method as claimed in claim 8, further comprising varying the respective feedforward of the respective electrode pair such that a predefinable lower output concentration is not undershot.

12. The method as claimed in claim 1, further comprising:
measuring values of an input dust sensor which is arranged fluidically upstream of the at least one electrode pair to measure an input concentration of the solid particles in the exhaust gas flowing into the filter system; and/or
measuring values of an output dust sensor which is arranged fluidically downstream of the at least one electrode pair to measure an output concentration of the solid particles in the exhaust gas flowing out of the filter system;
evaluating the measured values within the scope of the attempt to identify the process phase, and wherein the process phase is rated as not identifiable if the input dust sensor and/or the output dust sensor deliver/delivers unreliable measured values.

13. The method as claimed in claim 1, further comprising operating an emergency feedforward such that the respective electrode pair is operated as during that process phase during which the exhaust gas contains a maximum of solid particles and to achieve a greatest filtering effect.

14. The method as claimed in claim 1, further comprising applying a respective standby electrical power and/or standby electrical voltage and/or standby electrical current to the respective electrode pair in accordance with a respective standby feedforward if the metallurgical plant is operated in a standby state for longer than a predefinable period of time.

15. A system for operating a filter system for filtering an exhaust gas of a metallurgical plant, wherein the exhaust gas contains solid particles, the system comprising:
the filter system comprising at least one electrode pair, to each electrode of the at least one pair, an electrical power and/or an electrical voltage and/or an electrical current can be applied;
a computing unit configured for identifying a process phase of the metallurgical plant and a respective feedforward of the respective electrode pair, wherein for determining the respective feedforward which is dependent on the identified process phase, wherein the respective determined feedforward comprises a respective electrical power and/or a respective electrical voltage and/or a respective electrical current to be applied; and
wherein the computing unit is embodied to apply a respective emergency electrical power and/or a respective emergency electrical voltage and/or a respective emergency electrical current to the respective electrode pair in accordance with a respective emergency feedforward if the process phase cannot be identified.

16. A plant for filtering an exhaust gas of a metallurgical plant, which exhaust gas contains solid particles, the plant comprising:
a filter system for filtering the exhaust gas of the metallurgical plant, which exhaust gas contains solid particles;
wherein the filter system has at least one electrode pair, to each of which an electrical power and/or an electrical voltage and/or an electrical current can be applied; and
a system as claimed in claim 15.

17. The method as claimed in claim 8, further comprising storing the varied feedforward is stored in the predefinable table.
